(19) United States
(12) Patent Application Publication
(10) Pub. No.: US 2026/0342189 A1
(43) Pub. Date: Oct. 29, 2026

(54) AIRCRAFT-WHEEL ELECTRIC MOTOR, AIRCRAFT WHEEL, AND AIRCRAFT

(71) Applicant: AIRBUS SAS, Blagnac (FR)

(72) Inventors: François ROUYRE, Blagnac (FR); Didier CHASSAIGNE, Blagnac (FR); Olivier CREPEL, Blagnac (FR)

(73) Assignee: AIRBUS SAS, Blagnac (FR)

(21) Appl. No.: 19/322,369

(22) Filed: Sep. 8, 2025

(30) Foreign Application Priority Data
Sep. 13, 2024 (FR) 2409778

(51) Int. Cl. H02K 21/22; B64C 25/32; B64C 25/36

(52) U.S. Cl. CPC H02K 21/22; B64C 25/36; B64C 25/405

(57) ABSTRACT

An aircraft-wheel electric motor for an aircraft, including a through-bore and concentric rings of poles making it possible to obtain a torque capable of causing the aircraft to move while maintaining a bulk similar to conventional solutions. An aircraft wheel that includes such a motor, an aircraft-wheel command assembly, and an aircraft. Advantageously, it is thus possible to use an aircraft electric wheel in place of a conventional wheel, and do so without significant modification to the aircraft landing gears.

### TECHNICAL FIELD

The present invention relates to an aircraft wheel fitted with an electric motor. The invention relates more particularly to an architecture and arrangement of a brushless electric motor in an aircraft wheel.

### PRIOR ART

The aeronautical industry is undergoing profound changes in terms of aircraft design, with the aim of significantly reducing emissions of carbon dioxide and nitrogen oxides due to ecological and sustainable development constraints.

The increased use of electrical energy in aircraft systems makes it possible to limit fuel consumption in flight and on the ground and, therefore, to limit carbon dioxide emissions. On the ground, moving an aircraft around without using its main engines, when these are of the combustion engine type (for example turbojet or ducted fan engines) would allow a substantial saving on fuel. The use of wheels fitted with an electric motor for moving around on the ground is therefore highly attractive, but adapting known wheel types would require extensive modifications to existing aircraft landing gear.

The situation can be improved.

### SUMMARY OF THE INVENTION

One object of the present invention is to propose an electrically-motorized aircraft wheel that has dimensions similar to those of existing aircraft wheels, so is notably to allow it to be mounted on an aircraft landing gear axle without the need to perform extensive modifications.

To this end, what is proposed is an aircraft-wheel electric motor comprising a stator and a rotor which are concentric, the motor being arranged such that:
the motor has a through-bore arranged along a central axis that coincides with the central axis of the rotor and the central axis of the stator, and
at least part of said rotor is arranged inside said stator and vice versa, and
each of said stator and said rotor has at least two electromagnetic rings secured to one another with each of them bearing magnetic poles arranged to collaborate with magnetic poles arranged on a ring belonging to the other of either said rotor or said stator.

According to one embodiment, the through-bore has a profile that complements a profile of an aircraft landing gear axle.

According to one embodiment, each of said stator and rotor has a number greater than two of electromagnetic rings secured to one another, the rings being arranged concentrically with respect to one another about the through-bore and concentrically with same.

Another subject of the invention is an aircraft wheel comprising an electric motor as described hereinabove, a rim firmly secured to the electric motor and a tyre mounted on said rim at the periphery of said electric motor.

A further subject of the invention is an aircraft-wheel command assembly comprising a source of electrical energy, an aircraft-wheel electric motor as described hereinabove, and a control device controlling wound poles which are configured to control a relative rotational movement of the rotor with respect to the stator.

A final subject of the invention is an aircraft comprising at least one aircraft electric motor as described hereinabove or an aircraft-wheel command assembly as mentioned above.

### BRIEF DESCRIPTION OF THE DRAWINGS

FIG. 1 is a schematic perspective illustration of an aircraft-wheel electric motor according to one embodiment, assembled on an aircraft axle;

FIG. 2 is a schematic perspective illustration of a stator and a rotor that make up the aircraft-wheel electric motor already depicted in FIG. 1 and which are intended to be assembled on an aircraft axle, prior to being assembled;

FIG. 3 is a simplified sectional view of the aircraft-wheel electric motor already depicted in FIG. 1, assembled on an aircraft axle;

FIG. 4 is a symbolic depiction illustrating the architecture of the assembly formed by the combination of the rotor and the stator of the electric motor already depicted in FIG. 1, according to a first embodiment;

FIG. 5 is a symbolic depiction illustrating the architecture of the assembly formed by the combination of the rotor and the stator of the electric motor already depicted in FIG. 1, according to a second embodiment;

FIG. 6 schematically illustrates an aircraft-wheel command assembly comprising a control device for controlling the variable magnetic poles;

FIG. 7 is an example of an internal architecture of a control device for an aircraft-wheel electric motor, according to one exemplary embodiment; and

FIG. 8 symbolically illustrates an aircraft fitted with an aircraft-wheel electric motor as already depicted in FIG. 1.

### DETAILED DESCRIPTION OF EMBODIMENTS

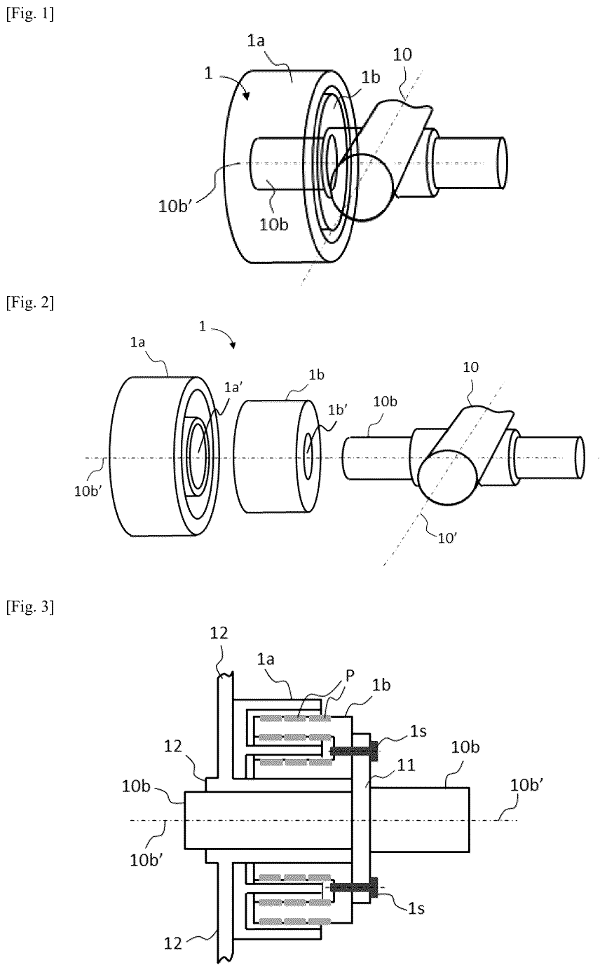

FIG. 1 is a schematic perspective depiction of an aircraft-wheel electric motor 1 assembled on an axle 10b of part of an aircraft landing gear 10 according to one embodiment. The aircraft landing gear part 10 is also referred to here as a “bogie” or “bogey” and forms a rocker beam at the ends of which are sited two parallel axle shafts each bearing one or more aircraft wheel(s). Thus, the axle 10b is part of one of these two parallel axle shafts. For the sake of simplicity, only the axle 10b extending along a longitudinal axis 10b′ is described here. The aircraft-wheel electric motor 1 is made up chiefly of a stator 1b and of a rotor 1a. According to the example described, the aircraft-wheel electric motor 1 is a motor referred to as brushless, designed to operate without the use of brushes. For example, the stator has electrical windings (or coils) that are configured to function as controlled variable magnetic poles and the stator has permanent magnetic poles so that a controlled application of power, in a determined order, to the variable magnetic poles of the stator, causes the rotor to turn. According to one exemplary embodiment, the relative and concentric position of the stator 1b and of the rotor 1a is provided by a transmission of the epicyclic type between an external surface of the rotor 1a and an internal surface of a rim of the wheel that comprises the wheel motor, secured to the rotor 1a, the rim comprising a central bore configured to be pushed onto the axle 10b. Planet-carrier shafts for supporting planet pinions are borne by the stator 1b. FIG. 2 depicts a perspective view of the same components, prior to assembly. The aircraft bogey extends along an axis 10′ which corresponds to an axis along which the aircraft moves in a straight line. Advantageously, the stator 1b has a central through-opening 1b′ and the rotor has a through-opening 1a′ enabling the rotor-stator assembly to be mounted on and around the aircraft landing gear axle 10b. Furthermore, it may be observed that the stator 1b has the overall external shape of a bell configured to be inserted at least partially inside the rotor 1a, which itself likewise has the overall external shape of a bell. Advantageously and cleverly, the through-opening thus formed by the combination of the through-opening 1b′ of the stator 1b and the through-opening 1a′ of the rotor 1a allows the aircraft-wheel electric motor 1 to be mounted on an aircraft bogey without the need for structural modification to the bogey. The result of this is that an aircraft wheel designed on the basis of such an electric motor is “backwards-compatible” with existing aircraft bogies, enabling existing landing gears to be upgraded without the need to make extensive structural modifications.

FIG. 3 is a simplified sectional view of the aircraft-wheel electric motor 1, assembled on the axle 10b. According to the assembly (which is to say mounting) example described, the stator 1b of the aircraft-wheel electric motor 1 is attached by screws 1s to a shoulder 11 of the axle 10b and the rotor 1a of the aircraft-wheel electric motor 1 is firmly secured to an aircraft wheel rim 12, which is configured to bear an aircraft tyre at the periphery of the rim 12. Thus, radial loadings are advantageously applied to the rim 12 alone, and the motor does not have to bear such radial loadings directly. Grey rectangles indicate variable magnetic poles P connected to a control device for controlling the aircraft-wheel electric motor 1. The stator-rotor assembly is thus “sandwiched” between the rim 12 and the shoulder 11 of the axle 10b. For this purpose, the rim 12 has the overall shape of a tube, configured to be pushed onto the axle 10b, and from which at least the body of the rim 12, which assumes the overall shape of a disc or of a circular plate, extends radially with respect to the axis 10b′, which axis is also an axis of rotation about which the rotor and the rim 12 are intended to rotate as one. The translational movement of the rim 12 along the axis 10b′ is limited in one direction by the shoulder 11 and in the other direction by translational-positioning and -blocking means which have not been depicted in the figures because such components are not needed for understanding the invention.

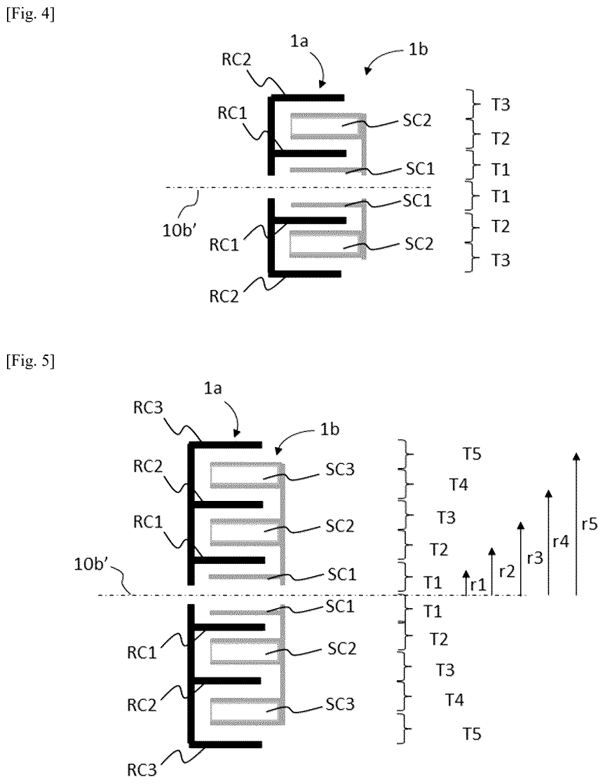

FIG. 4 is a symbolic depiction illustrating the architecture of the assembly formed by the combination of the rotor 1a and the stator 1b according to a first embodiment. According to this first embodiment, the stator 1b has at least two concentric magnetic rings SC1 and SC2 bearing evenly distributed windings configured to constitute variable magnetic poles. The ring SC1 constitutes an inner ring of the stator 1b and the ring SC2 constitutes an outer ring of the stator 1b. As far as the stator 1b is concerned, variable magnetic poles P are arranged and evenly distributed on the outer surface of the inner ring SC1 and on the inner and outer surfaces of the outer ring SC2, as has been illustrated in FIG. 1. As far as the rotor 1a is concerned, two concentric magnetic rings RC1 and RC2 bear permanent magnetic poles arranged and evenly distributed facing the magnetic poles P, namely on the inner and outer surfaces of the inner ring RC1 of the rotor 1a and on the inner surface of the outer ring RC2 of the rotor 1a. Cleverly, the rings of the stator 1b and of the rotor 1a are imbricated in one another, which means to say that the ring SC1 of the stator 1b is almost wholly inserted into the interior volume of the ring RC1 of the rotor 1a, which is itself almost wholly inserted into the interior volume of the ring SC2 of the stator 1b, this latter ring being almost wholly inserted into the interior volume of the ring RC2 of the rotor 1a.

The variable magnetic poles P of the stator 1b are intended to collaborate with the permanent magnetic poles of the rotor 1a to cause a relative rotation of the rotor 1a with respect to the stator 1b, according to the ordering of voltages applied to the electrical windings that make up the variable magnetic poles P. A control device for an electric motor of the brushless type (depicted in FIG. 7) is used to successively generate voltages and create rotary magnetic fields capable of causing rotational movement of the rotor 1a. Cleverly, the use of a magnetic “double ring” for both the rotor 1a and the stator 1b, the two “double rings” being imbricated in one another so as to create an alternation of variable magnetic poles and of permanent magnetic poles along radial axes, makes it possible to obtain a significant rotational torque because of the combined rotary magnetic fields that it is therefore possible to obtain in a total available cylindrical volume that is relatively small and suitable for being arranged in an aircraft wheel of the customary dimensions. Each combination of variable magnetic poles arranged on a surface of one of the aforementioned rings and of permanent magnetic poles arranged on a surface of an adjacent ring is referred to here, in the controlled electromagnetic architecture described as an “electromagnetic level” or “electromagnetic stage”. Thus, according to the example of the arrangement of the stator 1b combined with the arrangement of the rotor 1a, three concentric levels T1, T2 and T3 are used in combination to produce a rotary mechanical torque.

Such an arrangement cleverly allows a radial extension of the electromagnetic architecture previously described, by increasing the number of electromagnetic levels without requiring additional widthwise bulk (or volume). Thus, and as illustrated by way of example in FIG. 5, a so-called electromagnetic architecture bearing one or more additional stages may be obtained by adding concentric rings SC3 and RC3 that are imbricated in an arrangement similar to that already described with regard to the rings SC1 and SC2 in collaboration with the rings RC1 and RC2. The ring SC3 of the stator 1b collaborates with the rings RC2 and RC3 of the rotor 1a so that five concentric levels T1, T2, T3, T4 and T5 are therefore available to participate in generating a mechanical torque that can be used for driving the rotation of the rotor 1a with respect to the stator 1b. It is then possible to determine the mean radii r1, r2, r3, r4 and r5 of the circular air gaps created between the controlled variable magnetic poles and the permanent magnetic poles. These radii need to be taken into consideration in order to perform coherent voltage control of the various variable magnetic poles in such a way as to avoid creating “counter-productive” magnetic fields and to optimize the combined effect of the various rotary magnetic fields respectively created in the various electromagnetic stages employed with this architecture.

Thus, if V1 is the linear speed of travel of a point in the stage T1, it is appropriate to ensure that equality r1V1=r2V2=r3V3 is maintained where V2 and V3 are respectively the linear speeds of travel of point situated on the stages T2 and T3 and at the same radius as the point considered on the stage T1.

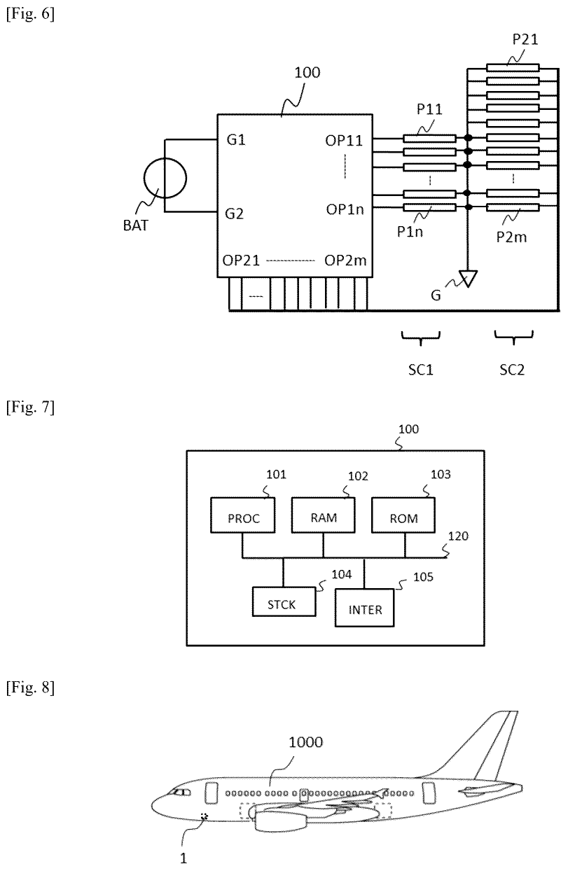

In order to do this, an aircraft-wheel command assembly comprising a control device 100 for controlling the variable magnetic poles is used in accordance with a principal illustrated schematically in FIG. 6. According to the example depicted, the control device 100 is connected to each of the variable magnetic poles P of the rings SC1 and SC2 of the stator 1b; the ring SC1 comprises n poles P P11 to P1n respectively connected to control outputs OP11 to OP1n and the ring SC2 comprises m poles P P21 to P2m respectively connected to control outputs OP21 to OP2m. The control outputs OP11 to OP1n and OP21 to OP2M are configured to deliver nominal and maximum currents suitable for operating the aircraft-wheel electric motor 1 under nominal conditions. Thus, the command assembly comprises electronic command and power circuitry suited to the requirements of the aircraft-wheel electric motor 1. Each of the variable magnetic poles P (namely P11 to P1n, P21 to P2m, etc . . . ) is connected on the one hand to a control output of the control device 100 and on the other hand to electrical ground G. Furthermore, the control device 100 is connected to an electrical supply BAT via supply inputs G1 and G2. Thus, the control device 100 is configured to generate a coherent ordering of voltages applied to the various poles of the various stages T1, T2, T3 or even T4 and T5, where applicable, so that the rotary magnetic fields of the various stages act together effectively without creating any (mutually) interfering or opposite-direction rotary torques.

FIG. 7 schematically illustrates one example of an internal architecture of the control device 100.

In the hardware-architecture example depicted in FIG. 7, the aircraft-wheel electric motor control device 100 then comprises, connected by a communication bus 120: a processor or CPU (acronym of Central Processing Unit) 101; a random-access memory (RAM) 102; a read-only memory (ROM) 103; a storage unit such as a hard disk (or a storage-medium reader such as an SD card reader (SD standing for Secure Digital)) 104; a communication-interface module 105 allowing the aircraft-wheel electric motor control device to communicate with remote devices, such as the variable magnetic poles P or else other systems on board the aircraft in which it is installed.

The processor 101 of the aircraft-wheel electric motor control device is capable of executing instructions loaded into the RAM 102 from the ROM 103, from an external memory (not shown), from a storage medium (such as an SD card), or from a communication network. When the aircraft-wheel electric motor control device 100 is powered up, the processor 101 is capable of reading instructions from the RAM 102 and of executing them. These instructions form a computer program which causes the processor 101 of the aircraft-wheel electric motor control device to implement all or part of a method for controlling the voltages applied to the variable magnetic poles P of the stator 1b.

All or part of such an aircraft-wheel electric motor command method may then be implemented in software form by executing a set of instructions using a programmable machine, for example a DSP (digital signal processor) or a microcontroller, or be implemented in hardware form by a machine or a dedicated component, for example an FPGA (field-programmable gate array) or ASIC (application-specific integrated circuit). In general, the aircraft-wheel electric motor control device 100 comprises electronic circuitry configured to implement a method for controlling the voltages to be applied to the variable magnetic poles P so as to create synchronized rotary magnetic fields and thus optimize the rotation torque obtained in an aircraft-wheel electric motor arranged according to the architecture described in the present description. Of course, the aircraft-wheel electric motor control device 100 further comprises all the elements that are usually present in a system comprising a control unit and its peripherals, such as, a power-supply circuit, a power-supply-monitoring circuit, one or more clock circuits, a zeroing circuit, input/output ports, interrupt inputs, and bus drivers, this list being non-exhaustive.

FIG. 8 is a schematic illustration of an aircraft 1000 comprising at least one electric motor such as the aircraft-wheel electric motor 1 arranged in one or more of its wheels. Advantageously, it is thus possible to perform phases of running or taxiing on the ground without requiring power derived from the combustion engines of the aircraft 1000, thereby making it possible to reduce the amount of carbon dioxide gas emissions. Furthermore, the use of an electric motor such as the electric motor 1 on board the aircraft 1000 advantageously makes it possible to avoid any structural modification to the landing gear of the aircraft 1000, which landing gear remains compatible with a conventional aircraft wheel. This greatly simplifies operations aimed at adapting aircraft electric wheels and maintenance operations associated with the wheels of the aircraft 1000.

1. An aircraft-wheel electric motor comprising a stator and a rotor which are concentric, wherein:
said motor has a through-bore arranged along a central axis that coincides with the central axis of said rotor and the central axis of said stator, and
at least part of said rotor is arranged inside said stator and vice versa, and
each of said stator and said rotor has at least two electromagnetic rings secured to one another with each of them bearing magnetic poles arranged to collaborate with magnetic poles arranged on a ring belonging to the other of either said rotor or said stator.

2. The aircraft-wheel electric motor according to claim 1, wherein said through-bore has a profile that complements a profile of an aircraft landing gear axle.

3. The aircraft-wheel electric motor according to claim 1, wherein each of said stator and rotor has a number greater than two of electromagnetic rings secured to one another, the magnetic rings being arranged concentrically with respect to one another about said through-bore and concentrically with same.

4. The aircraft wheel comprising an electric motor according to claim 1, a rim firmly secured to said electric motor and a tyre mounted on said rim at the periphery of said electric motor.

5. The aircraft-wheel command assembly comprising a source of electrical energy (BAT), an aircraft-wheel electric motor according to claim 1, and a control device controlling variable magnetic poles which are configured to control a relative rotational movement of said rotor with respect to said stator.

6. The aircraft comprising at least one aircraft electric motor according to claim 1.

7. The aircraft comprising an aircraft-wheel command assembly according to claim 5.
